(19) United States
(12) Patent Application Publication
(10) Pub. No.: US 2009/0121979 A1
(43) Pub. Date: May 14, 2009

(54) Method of driving plasma display panel

(76) Inventor: Joo-yul Lee, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/289,278

(22) Filed: Oct. 23, 2008

(30) Foreign Application Priority Data
Nov. 14, 2007 (KR) 10-2007-0116302

(51) Int. Cl. G09G 3/28

(52) U.S. Cl. 345/63

(57) ABSTRACT

A method of driving a plasma display panel (PDP) capable of improving gray scale display comprises the steps of applying pulses having a first voltage to first electrodes and second electrodes during a sustain period of at least one subfield and reducing a voltage of the first electrodes to a voltage of no more than one-half of the first voltage while maintaining a voltage of the second electrode at a second voltage.

### CLAIM OF PRIORITY

This application makes reference to, incorporates the same herein, and claims all benefits accruing under 35 U.S.C. §119 from an application for METHOD OF DRIVING PLASMA DISPLAY PANEL earlier filed in the Korean Intellectual Property Office on 14 Nov. 2007 and there duly assigned Serial No. 10-2007-0116302.

### BACKGROUND OF THE INVENTION

1. Field of the Invention

The present invention relates to a method of driving a plasma display panel (PDP) and, more specifically, relates to a method of driving a PDP capable of improving gray scale display.

2. Discussion of Related Art

A plasma display panel (PDP) emits light from phosphors using ultraviolet (UV) rays of 147 nm generated during the discharge of an inert gas mixture so as to display a predetermined image. The PDP can be easily made thin and large, and provides an image of remarkably improved picture quality due to recent technological development.

The PDP divides one frame into various subfields having different numbers of times of emission to be driven in order to realize the gray scales of an image. Each subfield is divided into a reset period for initializing an entire screen, an address period for selecting cells to be turned on, and a sustain period for realizing gray scales in accordance with the number of times of discharge.

In the reset period, ramp pulses are supplied to scan electrodes so as to generate reset discharge in discharge cells. Due to the reset discharge, wall charges required for address discharge uniformly reside in the discharge cells.

In the address period, scan pulses are sequentially supplied to scan electrodes, and data pulses are supplied to address electrodes. At this point, a voltage difference between the data pulses and the scan pulses and the wall voltage of the wall charges of the discharge cells formed in the reset period are added to each other so as to generate the address discharge. Due to the address discharge, predetermined wall charges are generated in the discharge cells.

In the sustain period, sustain pulses are alternately supplied to the scan electrodes and sustain electrodes. Then, the wall voltage in the discharge cells selected by the address discharge and the voltage of the sustain pulses are added to each other so that, whenever a sustain pulse is applied, surface discharge type sustain discharge is generated.

In the above-described conventional PDP, gray scales are realized using the number of sustain pulses. That is, in the conventional PDP, a large number of sustain pulses are supplied in order to display brightness of high gray scales, and a small number of sustain pulses are supplied in order to display brightness of low gray scales. However, when the gray scales are displayed using the number of sustain pulses, it is difficult to naturally (smoothly) display brightness. That is, since the gray scales are displayed using only the number of sustain pulses, it is difficult to realize a fine change in brightness.

In order to solve the problem, a method of not applying the sustain pulses in the sustain period of the subfield with the lowermost brightness that displays “1”, and of displaying the gray scales of “1” using light generated by the rising or falling ramp pulses of the next subfield, is provided (Korean Patent Publication No. 2006-0069773). However, when the sustain pulses are not applied in the sustain period but the ramp pulses of the next reset period are used, brightness corresponding to “1” becomes too low. In particular, when the sustain pulses are not applied but the ramp pulses of the next reset period are applied, the supply time of the ramp pulses has to be increased in order to stably generate discharge. Therefore, driving time increases.

### SUMMARY OF THE INVENTION

Accordingly, it is an object of the present invention to provide a plasma display panel (PDP) capable of improving gray scale display.

In order to achieve the foregoing and/or other objects of the present invention, according to a first embodiment of the present invention, a method of driving a plasma display panel (PDP) comprises applying pulses having a first voltage to first electrodes and second electrodes in a sustain period of at least one subfield, reducing a voltage of the first electrodes to no more than one-half of the first voltage, and maintaining a voltage of the second electrode at a second voltage.

The at least one subfield is a lowermost brightness subfield, the first electrodes are scan electrodes, the second electrodes are sustain electrodes, the first voltage is a sustain voltage, the second voltage is ground potential, and a voltage no more than one-half of the first voltage is a voltage supplied from an energy recovery circuit. The at least one subfield displays gray scales of “1”. A first sustain discharge is generated between the first electrodes and address electrodes in applying pulses having a first voltage to first electrodes and second electrodes in a sustain period of at least one subfield, and a second sustain discharge is generated between the first electrodes and the second electrodes in reducing a voltage of the first electrodes to no more than one-half of the first voltage and maintaining a voltage of the second electrode at a second voltage. Light generated by the first sustain discharge and the second sustain discharge displays the gray scales of “1”.

The method further comprises increasing a voltage of the second electrodes to the first voltage after reducing a voltage of the first electrodes to no more than one-half of the first voltage, and maintaining a voltage of the second electrode at a second voltage. A second rising transistor positioned between a sustain voltage source and the first electrodes, and a second rising transistor positioned between the sustain voltage source and the second electrodes, are simultaneously turned on in applying pulses having a first voltage to first electrodes and second electrodes in a sustain period of at least one subfield. A first falling switch positioned between the first electrodes and a source capacitor is turned on, and a first falling switch positioned between the second electrodes and the source capacitor and a second falling switch positioned between the second electrodes and ground potential are sequentially turned on in reducing a voltage of the first electrodes to no more than one-half of the first voltage and maintaining a voltage of the second electrode at a second voltage. A first rising transistor positioned between the second electrodes and the source capacitor and a second rising transistor positioned between a sustain voltage source and the second electrodes are sequentially turned on in order to increase the voltage of the second electrodes to the first voltage.

According to a second embodiment of the present invention, a method of driving a PDP comprises applying pulses having a first voltage to first electrodes and second electrodes in a sustain period of at least one subfield, and reducing a voltage of the second electrodes to no more than one-half of the first voltage after applying pulses having a first voltage to first electrodes and second electrodes in a sustain period of at least one subfield.

The at least one subfield is a lowermost brightness subfield, the first electrodes are scan electrodes, the second electrodes are sustain electrodes, the first voltage is a sustain voltage, and a voltage no more than one-half of the first voltage is supplied from an energy recovery circuit. The at least one subfield displays gray scales of “1”. A first sustain discharge is generated between the first electrodes and address electrodes in applying pulses having a first voltage to first electrodes and second electrodes in a sustain period of at least one subfield, and a second sustain discharge is generated between the first electrodes and the second electrodes in reducing a voltage of the second electrodes to no more than one-half of the first voltage after applying pulses having a first voltage to first electrodes and second electrodes in a sustain period of at least one subfield. Light generated by the first sustain discharge and the second sustain discharge displays the gray scales of “1”.

The method further comprises increasing a voltage of the second electrodes to the first voltage after reducing a voltage of the second electrodes to no more than one-half of the first voltage after applying pulses having a first voltage to first electrodes and second electrodes in a sustain period of at least one subfield. A second rising transistor positioned between a sustain voltage source and the first electrodes and a second rising transistor positioned between the sustain voltage source and the second electrodes are simultaneously turned on in applying pulses having a first voltage to first electrodes and second electrodes in a sustain period of at least one subfield. A falling switch positioned between the second electrodes and a source capacitor is turned on in reducing a voltage of the second electrodes to no more than one-half of the first voltage after applying pulses having a first voltage to first electrodes and second electrodes in a sustain period of at least one subfield. A second rising transistor positioned between a sustain voltage source and the second electrodes is turned on in order to increase the voltage of the second electrodes to the first voltage.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram of a plasma display panel (PDP) according to an embodiment of the present invention;

FIG. 2 shows driving waveforms of the lowermost brightness subfield according to a first embodiment of the present invention;

FIG. 3 is a diagram of an energy recovery circuit according to an embodiment of the present invention;

FIG. 4 shows driving waveforms of the lowermost brightness subfield according to a second embodiment of the present invention;

FIG. 5 shows driving waveforms of the lowermost brightness subfield according to a third embodiment of the present invention;

FIG. 6 shows driving waveforms of the lowermost brightness subfield according to a fourth embodiment of the present invention; and

FIGS. 7A and 7B are graphs illustrating brightness curves corresponding to gray scales.

### DETAILED DESCRIPTION OF THE INVENTION

Hereinafter, certain exemplary embodiments according to the present invention will be described with reference to the accompanying drawings. When a first element is described as being coupled to a second element, the first element may be not only directly coupled to the second element but may also be indirectly coupled to the second element via a third element. Furthermore, elements that are not essential to a complete understanding of the invention are omitted for clarity. Also, like reference numerals refer to like elements throughout.

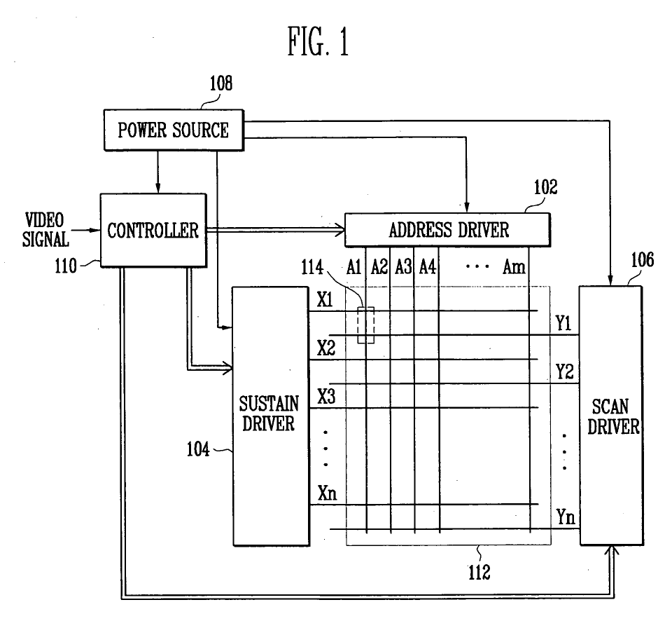

FIG. 1 is a diagram of a plasma display panel (PDP) according to an embodiment of the present invention.

Referring to FIG. 1, the PDP of the present invention includes an address driver 102, a sustain driver 104, a scan driver 106, a power source 108, a controller 110, and a display panel 112.

The display panel 112 includes scan electrodes Y1 to Yn (or first electrodes) and sustain electrodes X1 to Xn (or second electrodes) that run parallel with each other, and address electrodes A1 to Am that intersect the scan electrodes Y1 to Yn. In the latter regard, discharge cells 114 are formed in the parts where the scan electrodes Y1 to Yn, the sustain electrodes X1 to Xn, and the address electrodes A1 to Am intersect each other. The structure of the electrodes Y, X, A which form the discharge cells 114 is in accordance with the present invention. The present invention is not limited to the above.

The controller 110 receives image signals from an external source so as to generate control signals for controlling the address driver 102, the sustain driver 104, and the scan driver 106. The controller 110 generates control signals so that one frame is divided into a plurality of subfields, each having a reset period, an address period, and a sustain period to be driven.

The address driver 102 supplies data pulses to the address electrodes A1 to Am in response to the control signals supplied by the controller 110 in the address period of each subfield. Therefore, the address driver 102 selects discharge cells 114 to be turned on.

The sustain driver 104 supplies sustain pulses to the sustain electrodes X1 to Xn in response to the control signals supplied by the controller 110 in the sustain period of each subfield.

The scan driver 106 controls driving waveforms supplied to the scan electrodes Y1 to Yn in response to the control signals supplied by the controller 110. That is, the scan driver 106 supplies the ramp pulses to the scan electrodes Y1 to Yn in the reset period of each subfield, and sequentially supplies scan pulses in the address period. In addition, the scan driver 106 supplies the sustain pulses to the scan electrodes Y1 to Yn so as to alternate with the sustain electrodes X1 to Xn in the sustain period of each subfield. The power source 108 supplies a power source required for driving the PDP to the controller 110 and the drivers 102, 104, and 106.

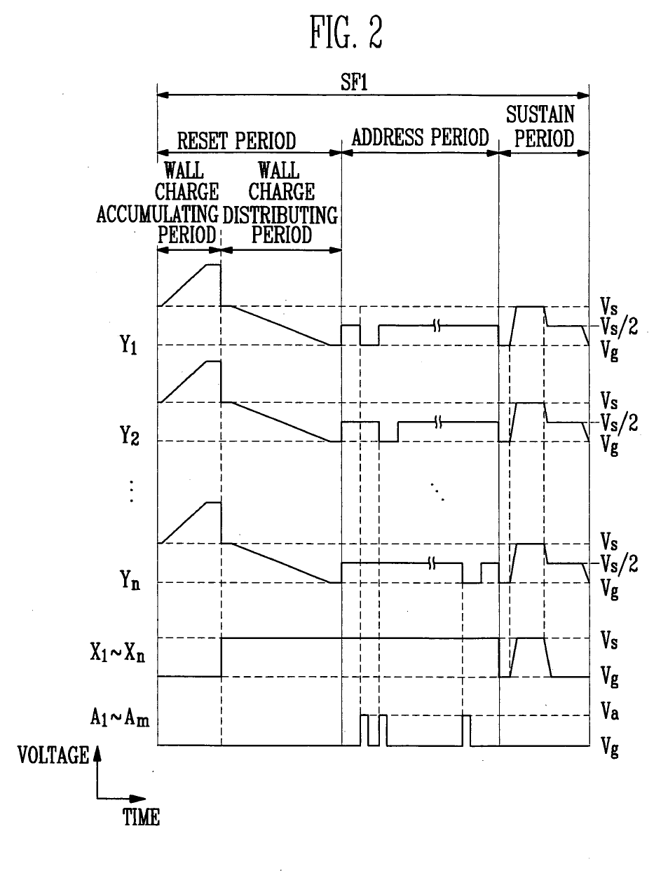

FIG. 2 shows driving waveforms of the lowermost brightness subfield according to a first embodiment of the present invention. The lowermost brightness subfield is to display gray scales of “1”. In FIG. 2, the driving waveforms supplied in the reset period and the address period are in accordance with an embodiment of the present invention, but the present invention is not limited to the above. The lowermost brightness subfield is included in one frame, and a plurality of subfields other than the lowermost brightness subfield are additionally included in one frame.

Referring to FIG. 2, the lowermost brightness subfield is divided into a reset period, an address period, and a sustain period.

In the reset period, during a wall charge accumulating period, ramp pulses that rise with a predetermined slope are supplied to the scan electrodes Y1 to Yn and ground potential Vg is applied to the sustain electrodes X1 to Xn and the address electrodes A1 to Am. Then, negative polar wall charges are accumulated on the scan electrodes Y1 to Yn and positive polar wall charges are accumulated on the sustain electrodes X1 to Xn due to micro-discharge caused by the ramp pulses.

During a wall charge distribution period of the reset period, ramp pulses that fall with a predetermined slope are supplied to the scan electrodes Y1 to Yn and a predetermined voltage is applied to the sustain electrodes X1 to Xn. When the falling ramp pulses are supplied to the scan electrodes Y1 to Yn, the micro-discharge is generated in the discharge cells 114. Wall charges formed during the wall charge accumulating period are partially reduced by the micro-discharge. That is, during the wall charge distribution period, the amount of wall charge accumulated on the discharge cells 114 is reduced to prevent excessively strong discharge from being generated during the address period.

In the address period, the scan signals are sequentially supplied to the scan electrodes Y1 to Yn and the data signals synchronized with the scan signals are supplied to the address electrodes A1 to Am. Then, the voltage difference between the scan signals and the data signals, and the wall voltage formed during the reset period, are added to each other so that the address discharge is generated in the discharge cells to which the data signals are applied. Wall charges required for the sustain discharge are generated in the discharge cells where the address discharge is generated.

In the sustain period, the sustain pulses are simultaneously supplied to the scan electrodes Y1 to Yn and the sustain electrodes X1 to Xn, and the ground potential Vg (or a second voltage) is applied to the address electrodes A1 to Am. When the sustain pulses are supplied to the scan electrodes Y1 to Yn and the sustain electrodes X1 to Xn, the voltages of the scan electrodes Y1 to Yn and the sustain electrodes X1 to Xn are increased to a sustain voltage Vs (or a first voltage). At this point, first sustain discharge is generated between the scan electrodes Y1 to Yn and the address electrodes A1 to Am due to the wall charges formed by the address discharge.

To be specific, the positive polar wall charges are formed in the scan electrodes Y and the negative polar wall charges are formed in the address electrodes A in the discharge cells where the address discharge is generated. Therefore, when the sustain pulses are supplied to the scan electrodes Y during the sustain period, a first sustain discharge is generated between the scan electrodes Y and the address electrodes A. At this point, in the discharge cells where the address discharge is not generated during the address period, discharge is not generated between the scan electrodes Y and the address electrodes A.

After the micro-discharge is generated between the scan electrodes Y and the address electrodes A, the voltage of the scan electrodes Y1 to Yn is reduced to one-half (Vs/2) (actually, a voltage no more than one-half) of the sustain voltage Vs. Then, the voltage of the sustain electrodes X1 to Xn is reduced to the ground potential Vg. At this point, a second sustain discharge is generated between the scan electrodes Y1 to Yn and the sustain electrodes X1 to Xn.

When the voltage of Vs/2 is applied to the scan electrodes Y and the ground potential Vg is applied to the sustain electrodes X, the voltage difference between the scan electrodes Y and the sustain electrodes X is set at Vs/2. In this case, the second sustain discharge is generated between the scan electrodes Y and the sustain electrodes X. Actually, the second sustain discharge is stably generated by the voltage difference of Vs/2 in the discharge cells due to priming charged particles caused by the first sustain discharge.

To be specific, in the PDP, the voltage difference of the sustain voltage Vs is commonly generated between the scan electrodes Y and the sustain electrodes X so as to generate the sustain discharge. In this regard, the voltage difference of the sustain voltage Vs is applied so that sufficient wall charges are formed between the scan electrodes Y and the sustain electrodes X in order to continuously generate the sustain discharge. However, according to the present invention, since discharge is required between the sustain electrodes X and the scan electrodes Y only once, the sustain discharge is generated using the voltage difference of Vs/2 between the sustain electrodes X and the scan electrodes Y. At this point, the gray scales can be displayed by light generated by the discharge between the sustain electrodes X and the scan electrodes Y.

As described above, according to the present invention, the gray scales of “1” are displayed using the first sustain discharge between the scan electrodes Y and the address electrodes X, and the second sustain discharge between the scan electrodes Y and the sustain electrodes X. Since opposed discharge is generated between the scan electrodes Y and the address electrodes X, light generated by the first sustain discharge is rarely observed in the outside. Since the second sustain discharge between the scan electrodes Y and the sustain electrodes X is generated by the voltage difference of Vs/2, it is possible to minimize the amount of light observed in the outside. That is, in the lowermost brightness subfield according to the present invention, the gray scales of “1” can be realized only by light of micro-brightness. Since the wall charges excessively formed in the scan electrodes Y and the address electrodes X are partially removed by the first sustain discharge of the scan electrodes Y and the address electrodes X, driving can be stably performed during the reset period of the next subfield.

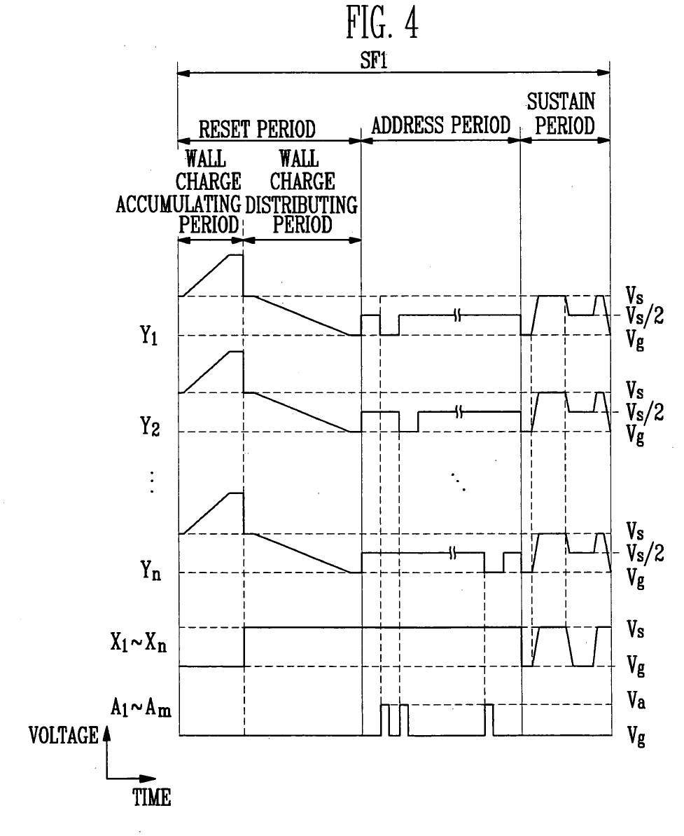

On the other hand, in FIG. 2, the driving waveforms supplied during the sustain period are ideally displayed without considering the driving waveforms supplied during the reset period of the next subfield. Actually, the driving waveforms supplied during the sustain period of the lowermost brightness subfield can be applied as illustrated in FIG. 4 so that the driving waveforms can be stably supplied during the reset period of the next subfield. At this point, although the driving waveforms illustrated in FIG. 4 are applied, since the same discharge as in FIG. 2 is generated, the same gray scales are displayed.

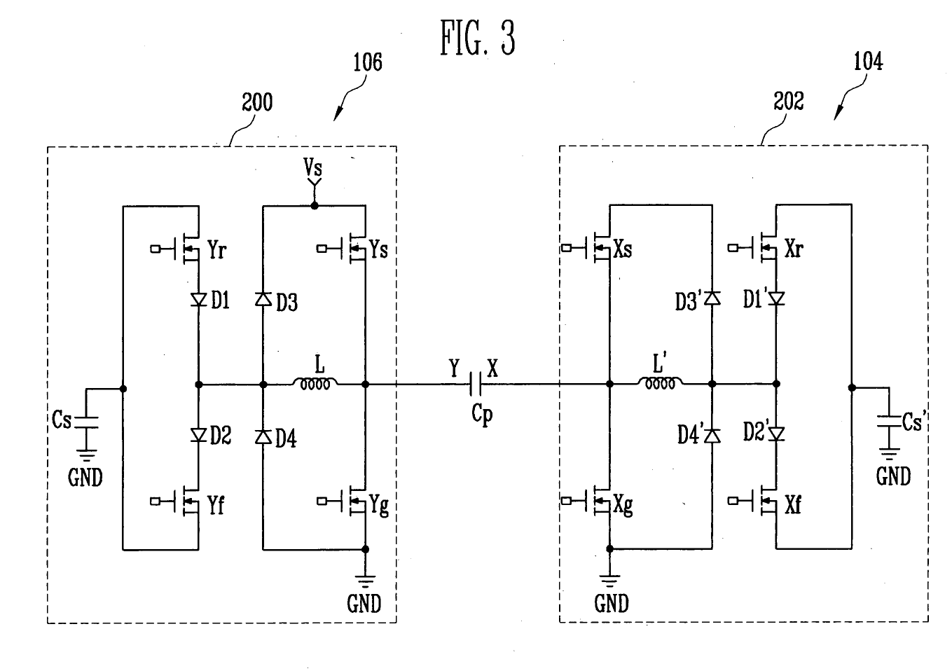

FIG. 3 is a diagram of an energy recovery circuit according to an embodiment of the present invention. FIG. 4 shows driving waveforms of the lowermost brightness subfield according to a second embodiment of the present invention. The lowermost brightness subfield is generated by the energy recovering circuit of FIG. 3. In FIG. 3, only an energy recovery circuit for supplying the sustain pulses is illustrated among the plurality of components included in the scan driver 106 and the sustain driver 104.

Referring to FIG. 3, energy recovery circuits 200 and 202 for recovering and re-supplying the energy of a panel capacitor Cp are provided in the scan driver 106 and the sustain driver 104, respectively. Since the structures of the energy recovery circuits 200 and 202 are the same, only the structure of the energy recovery circuit 200 included in the scan driver 106 will be described.

The energy recovery circuit 200 supplies the sustain pulses during the sustain period of each subfield. At this point, the energy recovery circuit 200 recovers energy charged in the panel capacitor Cp and supplies the sustain pulses using the recovered energy. Therefore, power consumption is reduced when the energy sustain pulses are supplied. The energy recovery circuit 200 includes transistors Yr, Yf, Ys, and Yg, diodes D1 to D4, a source capacitor Cs, and an inductor L.

The source capacitor Cs recovers energy from the panel capacitor Cp during the sustain period so as to charge a voltage and to re-supply the charged voltage to the panel capacitor Cp. Therefore, the source capacitor Cs has a capacity that can charge the voltage Vs/2 corresponding to one-half of the sustain voltage Vs. On the other hand, the panel capacitor CP equivalently illustrates the scan electrodes Y and the sustain electrodes X of the discharge cells.

The inductor L is positioned between the source capacitor Cs and the panel capacitor Cp. The inductor L forms a resonance circuit together with the panel capacitor Cp. Therefore, a voltage supplied from the source capacitor Cs to the panel capacitor Cp is increased up to about the sustain voltage Vs.

The first rising transistor Yr is positioned between the inductor L and the source capacitor Cs. The first rising transistor Yr is turned on when a voltage is supplied from the source capacitor Cs to the panel capacitor Cp.

The first falling transistor Yf is positioned between the inductor L and the source capacitor Cs. The first falling transistor Yf is turned on when energy is recovered from the panel capacitor Cp to the source capacitor Cs.

The second rising transistor Ys is positioned between the sustain voltage source Vs and the panel capacitor Cp. The second rising transistor Ys is turned on after a voltage is primarily supplied from the source capacitor Cs to the panel capacitor Cp. Then, the sustain voltage Vs is supplied to the panel capacitor Cp so that the sustain discharge can be stably generated.

The second falling transistor Yg is positioned between a base voltage source GND and the panel capacitor Cp. The second falling transistor Yg is turned on when a base potential is supplied to the panel capacitor Cp. The diodes D1 to D4 control the flow of current.

The energy recovery circuit 202 included in the sustain driver 104 includes transistors Xr, Xf, Xs, and Xg, diodes D1′ to D4′, a source capacitor Cs′, and an inductor L′. The positions and the structures of the transistors Xr, Xf, Xs, and Xg, the diodes D1′ to D4′, the source capacitor Cs′, and the inductor L′ included in the sustain driver 104 are the same as the positions and the structures of the transistors Yr, Yf, Ys, and Yg, the diodes D1 to D4, the source capacitor Cs, and the inductor L of the energy recovery circuit 200 included in the scan driver 106. Therefore, a detailed description thereof will be omitted.

The operations of the energy recovery circuits 200 and 202 for realizing the gray scales of “1” will be described in detail with reference to FIG. 4.

First, in the initial stage of the sustain period, the second rising transistors Ys and Xs are turned on. When the second rising transistors Ys and Xs are turned on, the voltages of the scan electrodes Y and the sustain electrodes X are increased to the sustain voltage Vs. At this point, the first sustain discharge is generated between the scan electrodes Y and the address electrodes A.

Then, in the energy recovery circuit 200 of the scan driver 106, the second rising transistor Ys is turned off and the first falling transistor Yf is turned on.

When the first falling transistor Yf is turned on, the source capacitor Cs, the inductor L, and the scan electrodes Y are electrically coupled with each other. In this case, a partial voltage of a voltage applied to the scan electrodes Y is recovered to the source capacitor Cs so that the voltage of the scan electrodes Y is reduced to the voltage of Vs/2.

In the energy recovery circuit 202 of the sustain driver 104, the second rising transistor Xs is turned off and the first falling transistor Xf is turned on. When the first falling transistor Xf is turned on, the partial voltage of the voltage applied to the sustain electrodes Y is recovered to the source capacitor Cs′. Then, the first falling transistor Xf is turned off and the second falling transistor Xg is turned on. When the second falling transistor Xg is turned on, the voltage of the sustain electrodes X is reduced to the voltage of the ground potential GND. That is, as illustrated in FIG. 4, the potential of the scan electrodes Y is maintained at the voltage of Vs/2 and the potential of the sustain electrodes X is sustained at the ground potential GND. At this point, the second sustain discharge is generated between the scan electrodes Y and the sustain electrodes X.

Then, the first rising transistor Xr of the energy recovery circuit 202 of the sustain driver 104 is turned on. When the first rising transistor Xr is turned on, a voltage charged in the source capacitor Cs′ is supplied to the sustain electrodes X via the inductor L′. At this point, due to a resonance phenomenon, the voltage of the sustain electrodes X is increased to about the voltage of Vs. After the voltage of the sustain electrodes X is increased to about the sustain voltage Vs, the second rising transistor Xs is turned on. When the second rising transistor Xs is turned on, the voltage of the sustain electrodes X is stably maintained at the sustain voltage Vs. On the other hand, when the voltage of the sustain electrodes X is increased, the voltage of the scan electrodes Y is also increased in response to the voltage increase in the sustain electrodes X. To be specific, when the voltage of the sustain electrodes X is increased, the first falling transistor Yf is turned on. In this case, the scan electrodes Y are not coupled with a specific voltage source but with the source capacitor Cs. Therefore, when the voltage of the sustain electrodes X is increased, the voltage of the scan electrodes Y is partially increased by the coupling of the panel capacitor Cp.

Then, the second falling transistor Yg of the scan driver 106 is turned on so that the voltage of the scan electrodes Y is reduced to the ground potential GND. Then, predetermined driving waveforms are applied in the reset period of the next subfield of the lowermost brightness subfield. For example, erase ramp pulses that fall from the ground potential GND are applied to the scan electrodes Y in the reset period of the next subfield and the sustain electrodes X maintain the sustain voltage Vs.

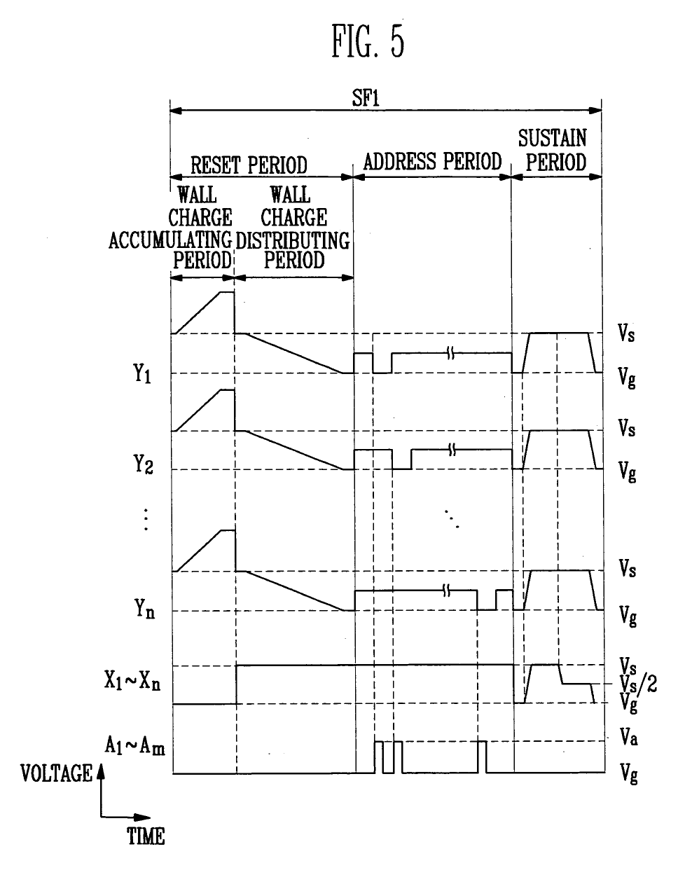

FIG. 5 shows driving waveforms of the lowermost brightness subfield according to a third embodiment of the present invention. In FIG. 5, a detailed description of the reset period and the address period set to have the same driving waveforms as FIG. 2 will be omitted.

Referring to FIG. 5, in the sustain period of the lowermost brightness subfield driving waveforms according to the third embodiment of the present invention, the sustain pulses are simultaneously supplied to the scan electrodes Y1 to Yn and the sustain electrodes X1 to Xn, and the ground potential Vg is applied to the address electrodes A1 to Am. When the sustain pulses are supplied to the scan electrodes Y1 to Yn and the sustain electrodes X1 to Xn, the voltages of the scan electrodes Y1 to Yn and the sustain electrodes X1 to Xn are increased to the sustain voltage Vs. At this point, the first sustain discharge is generated between the scan electrodes Y1 to Yn and the address electrodes A1 to Am due to the wall charges formed by the address discharge.

To be specific, in the discharge cells where the address discharge is generated, positive polar wall charges are formed in the scan electrodes Y and negative polar wall charges are formed in the address electrodes A. Therefore, when the sustain pulses are supplied to the scan electrodes Y in the sustain period, the first sustain discharge is generated between the scan electrodes Y and the address electrodes A. At this point, in the discharge cells where the address discharge is not generated during the address period, discharge is not generated between the scan electrodes Y and the address electrodes A.

After micro-discharge is generated between the scan electrodes Y and the address electrodes A, the voltage of the scan electrodes Y1 to Yn is maintained at the sustain voltage Vs. Then, the voltage of the sustain electrodes X1 to Xn is reduced to the voltage of one-half (Vs/2) of the sustain voltage Vs. At this point, the second sustain discharge is generated between the scan electrodes Y1 to Yn and the sustain electrodes X1 to Xn.

When the sustain voltage Vs is applied to the scan electrodes Y and the voltage of Vs/2 is applied to the sustain electrodes, the voltage difference between the scan electrodes Y and the sustain electrodes X is set to Vs/2. In this case, the second sustain discharge is generated between the scan electrodes Y and the sustain electrodes X. Actually, the second sustain discharge is stably generated by the voltage difference of Vs/2 in the discharge cells due to the priming charged particles caused by the first sustain discharge.

As described above, according to the present invention, the gray scales of “1” are displayed using the first sustain discharge between the scan electrodes Y and the address electrodes X and the second sustain discharge between the scan electrodes Y and the sustain electrodes X. Since an opposing discharge is generated between the scan electrodes Y and the address electrodes X, light generated by the first sustain discharge is rarely observed outside. Since the second sustain discharge between the scan electrodes Y and the sustain electrodes X is generated by the voltage difference of Vs/2, it is possible to minimize the amount of light observed outside.

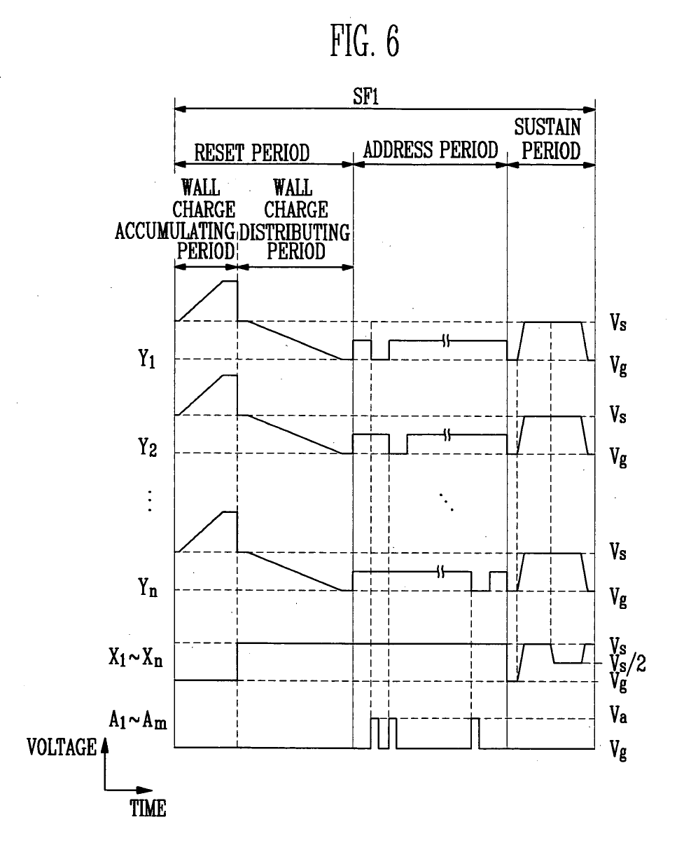

On the other hand, in FIG. 5, the driving waveforms supplied in the sustain period are ideal. For example, the driving waveforms supplied in the sustain period can be applied as illustrated in FIG. 6 so that the driving waveforms positioned during the reset period of the next subfield of the lowermost brightness subfield can be stably supplied. That is, as illustrated in FIG. 6, after the second sustain discharge, the voltage of the sustain electrodes X1 to Xn is increased to the sustain voltage Vs so that the sustain voltage Vs is maintained during the partial period of the next reset period.

FIG. 6 shows driving waveforms of the lowermost brightness subfield according to a fourth embodiment of the present invention.

The processes of generating the driving waveforms of FIG. 6 will be described as follows with reference to the energy recovery circuit of FIG. 3.

First, the second rising transistors Ys and Xs are turned on during the initial stage of the sustain period. When the second rising transistors Ys and Xs are turned on, the voltages of the scan electrodes Y and the sustain electrodes X are increased to the sustain voltage Vs. At this point, the first sustain discharge is generated between the scan electrodes Y and the address electrodes A. Then, in the energy recovery circuit 202 of the sustain driver 104, the second rising transistor Xs is turned off and the first falling transistor Xf is turned on.

When the first falling transistor Xf is turned on, the source capacitor Cs′, the inductor L′, and the sustain electrodes X are electrically coupled with each other. In this case, a partial voltage of the voltage applied to the sustain electrodes X is recovered to the source capacitor Cs so that the voltage of the sustain electrodes X is reduced to the voltage of Vs/2. At this point, the second sustain discharge is generated between the scan electrodes Y and the sustain electrodes X.

Then, the first falling transistor Yf and the second falling transistor Yg of the scan driver 106 are sequentially turned on so that the voltage of the scan electrodes Y is reduced to the ground potential GND through Vs/2. Then, the second rising transistor Xs of the sustain driver 104 is turned on so that the voltage of the sustain electrodes X is increased to the sustain voltage Vs. Then, predetermined driving waveforms are applied during the reset period of the next subfield of the lowermost brightness subfield. For example, during the reset period of the next subfield, the erase ramp pulses that fall from the ground potential GND are applied to the scan electrodes Y and the sustain electrodes X are maintained at the sustain voltage Vs.

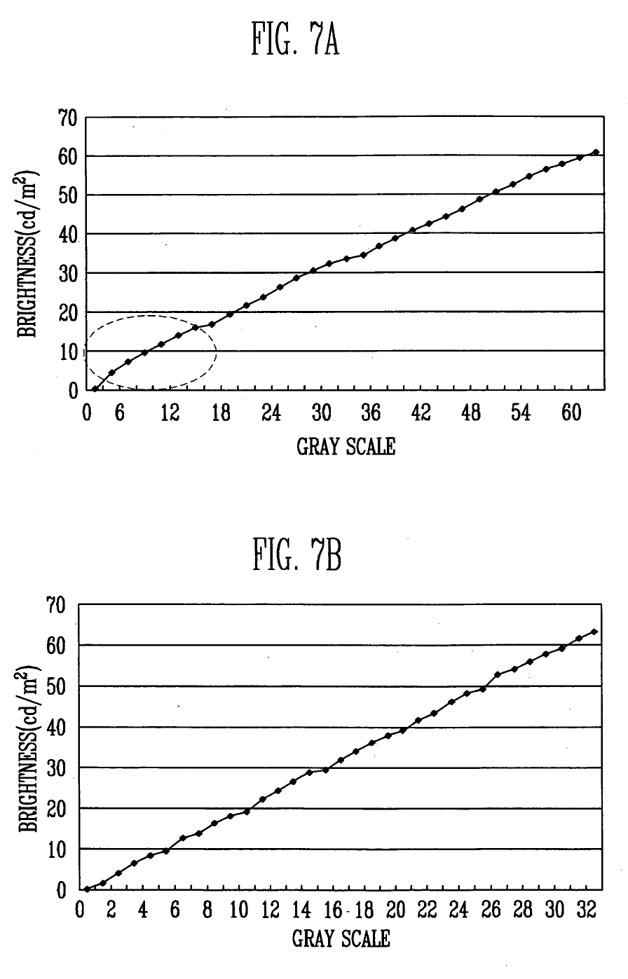

FIGS. 7A and 7B are graphs illustrating brightness curves corresponding to gray scales. In the brightness graph of FIG. 7B, the brightness of “1” is applied to the driving waveforms of FIG. 4 and the brightness of “2” is applied to the pair of sustain pulses.

In the conventional art, the brightness corresponding to the gray scales is not linearly increased at low brightness. Thus, gray scale linearity is not secured at low gray scales. Therefore, it is difficult to display a natural image.

However, according to the present invention, and referring to FIGS. 7A and 7B, the brightness corresponding to the gray scales is linearly increased at low brightness. Therefore, it is possible to secure the gray scale linearity at low gray scales. Thus, it is possible to smoothly display an image at low gray scales.

Although exemplary embodiments of the present invention have been shown and described, it will be appreciated by those skilled in the art that changes can be made in these embodiments without departing from the principles and spirit of the invention, the scope of which is defined in the claims and their equivalents.

What is claimed is:

1. A method of driving a plasma display panel (PDP), comprising the steps of:
applying pulses having a first voltage to first electrodes and second electrodes during a sustain period of at least one subfield; and
reducing a voltage of the first electrodes to a voltage of no more than one-half of the first voltage and maintaining a voltage of the second electrodes at a second voltage.

2. The method as recited in claim 1, wherein:
said at least one subfield is a lowermost brightness subfield;
the first electrodes are scan electrodes;
the second electrodes are sustain electrodes;
the first voltage is a sustain voltage;
the second voltage is a ground potential; and
the voltage of no more than one-half of the first voltage is supplied from an energy recovery circuit.

3. The method as recited in claim 1, wherein said at least one subfield displays gray scales of “1”.

4. The method as recited in claim 1, wherein:
a first sustain discharge is generated between the first electrodes and address electrodes in applying pulses having the first voltage to the first electrodes and the second electrodes in the sustain period of said at least one subfield; and
a second sustain discharge is generated between the first electrodes and the second electrodes in reducing the voltage of the first electrodes to the voltage of no more than one-half of the first voltage and maintaining the voltage of the second electrode at the second voltage.

5. The method as recited in claim 4, wherein light generated by the first sustain discharge and the second sustain discharge displays the gray scales of “1”.

6. The method as recited in claim 1, further comprising the step of increasing the voltage of the second electrodes up to the first voltage after reducing the voltage of the first electrodes to the voltage of no more than one-half of the first voltage and maintaining the voltage of the second electrodes at the second voltage.

7. The method as recited in claim 1, further comprising the step of providing a first rising transistor positioned between a sustain voltage source and the first electrodes and a second rising transistor positioned between the sustain voltage source and the second electrodes, wherein the first and second rising transistors are simultaneously turned on during the step of applying the pulses having the first voltage to the first electrodes and the second electrodes during the sustain period of said at least one subfield.

8. The method as recited in claim 7, further comprising the step of providing a first falling switch positioned between the first electrodes and a source capacitor, a second falling switch positioned between the second electrodes and the source capacitor, and a third falling switch positioned between the second electrodes and ground potential, wherein the first falling switch is turned on and the second and third falling switches are sequentially turned on during the step of reducing the voltage of the first electrodes to the voltage of no more than one-half of the first voltage and maintaining the voltage of the second electrode at the second voltage.

9. The method as recited in claim 6, further comprising the step of providing a first rising transistor positioned between the second electrodes and the source capacitor and a second rising transistor positioned between a sustain voltage source and the second electrodes, wherein the first and second rising transistors are sequentially turned on in order to increase the voltage of the second electrodes to the first voltage.

10. A method of driving a plasma display panel (PDP), comprising the steps of:
applying pulses having a first voltage to first electrodes and second electrodes during a sustain period of at least one subfield; and
reducing a voltage of the second electrodes to a voltage of no more than one-half of the first voltage after applying the pulses having the first voltage to the first electrodes and the second electrodes during the sustain period of said at least one subfield.

11. The method as recited in claim 10, wherein:
said at least one subfield is a lowermost brightness subfield;
the first electrodes are scan electrodes;
the second electrodes are sustain electrodes;
the first voltage is a sustain voltage; and
the voltage of no more than one-half of the first voltage is supplied from an energy recovery circuit.

12. The method as recited in claim 10, wherein said at least one subfield displays gray scales of “1”.

13. The method as recited in claim 10, wherein:
a first sustain discharge is generated between the first electrodes and address electrodes in applying pulses having the first voltage to the first electrodes and the second electrodes in the sustain period of said at least one subfield; and
the second sustain discharge is generated between the first electrodes and the second electrodes in reducing the voltage of the second electrodes to the voltage of no more than one-half of the first voltage after applying the pulses having the first voltage to the first electrodes and the second electrodes in the sustain period of said at least one subfield.

14. The method as recited in claim 13, wherein light generated by the first sustain discharge and the second sustain discharge displays the gray scales of “1”.

15. The method as recited in claim 10, further comprising the step of increasing the voltage of the second electrodes up to the first voltage after reducing the voltage of the second electrodes to the voltage of no more than one-half of the first voltage after applying the pulses having the first voltage to the first electrodes and the second electrodes during the sustain period of said at least one subfield.

16. The method as recited in claim 10, further comprising the step of providing a first rising transistor positioned between a sustain voltage source and the first electrodes and a second rising transistor positioned between the sustain voltage source and the second electrodes, wherein the first and second rising transistors are simultaneously turned on during the step of applying the pulses having the first voltage to the first electrodes and the second electrodes during the sustain period of said at least one subfield.

17. The method as recited in claim 16, further comprising the step of providing a falling switch positioned between the second electrodes and a source capacitor, wherein the falling switch is turned on in reducing the voltage of the second electrodes to the voltage of no more than one-half of the first voltage after applying the pulses having the first voltage to the first electrodes and the second electrodes during the sustain period of said at least one subfield.

18. The method as recited in claim 15, further comprising the step of providing a second rising transistor positioned between a sustain voltage source and the second electrodes, wherein the second rising transistor is turned on in order to increase the voltage of the second electrodes to the first voltage.
